(19) United States
(12) Patent Application Publication
(10) Pub. No.: US 2003/0142980 A1
(43) Pub. Date: Jul. 31, 2003

(54) Optical communication network and optical communication network designing method used therefor

(75) Inventor: Teruyuki Baba, Minato-ku (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/352,984

(22) Filed: Jan. 29, 2003

(30) Foreign Application Priority Data
Jan. 31, 2002 (JP) 2002-022717

(51) Int. Cl. H04J 14/00

(52) U.S. Cl. 398/56; 398/57

(57) ABSTRACT

An optical communication network is provided for reducing a required number of transmitters and receivers. A management device gives the amount of traffic passing through optical cross-connect devices along a route as an evaluation value for the route (step S6), and selects the route which has the largest evaluation value (step S7). The management device determines whether or not the evaluation value given to the selected candidate route is larger than a predefined reference value (step S8). When larger than the reference value, the management device outputs the route as an optical transmission path which includes at least one or more optical add-drop multiplexers (step S9).

### BACKGROUND OF THE INVENTION

1. Field of the Invention

The present invention relates to an optical communication network and an optical communication network designing method used therefor, and more particularly, to an optical communication network designing method for determining sites in which one or more optical add-drop multiplexers (OADM) are installed between a transmitter and a receiver as well as an order in which the optical add-drop multiplexers are arranged such that an optical transmission path including these components is economically routed between the transmitter and receiver.

2. Description of the Related Art

The above-mentioned optical add-drop multiplexer (hereinafter abbreviated as “OADM”) has a function of inserting (adding) an optical signal into an optical transmission path or branching (dropping) an optical signal from an optical transmission path.

Conventionally, as described in an article entitled “Arrangement of Light Wave Paths to Light Wave Network Having a Plurality of Fibers in One Link” published in Transactions of the Institute of Electronics, Information and Communications Engineers B-I, Vol. J80-B-I, No. 10, pp. 752-765, 1997, this type of optical communication network designing method is used for determining a procedure for arranging light wave paths to minimize a required number of waveform converters. FIG. 1 illustrates a procedure for setting all required light wave paths as mentioned above.

In the illustrated setting procedure, all light wave paths are preliminarily located such that they define the shortest paths (step S41). In this event, the Dijkstra's shortest path method or the like may be used for determining the shortest paths.

Next, in the setting procedure, the light wave paths are definitely located. First, cost C(i,j) is set between optical cross connect (XC) devices (steps S42-S46).

Cost C(i,j) indicates a cost for a link which is set between optical XC device i and optical XC device j. In the setting procedure mentioned above, cost C(i,j) is set to distance Ma between optical XC devices i, j when link (i,j) exists between optical XC device i and optical XC device j, while cost C(i,j) is set to infinite when no link (i,j) exists (step S42).

Subsequently, in the setting procedure mentioned above, if light wave paths have been set for link (i,j) in the preliminary location, a product of certain coefficient Mb and the number Cb of light wave paths set for link (i,j) during the preliminary location is added to cost C(i,j) (step S43).

In the setting procedure mentioned above, when light wave paths have been set for link (i,j) in the definitive location, a product of certain coefficient Mc and the number Cc of light wave paths previously set in the definitive location is added to cost C(i,j) (step S44).

Also, in the setting procedure mentioned above, certain constant Md is added to cost C(i,j) when link (i,j) has a remaining resource equal to one, while cost C(i,j) is set to infinite when the remaining resource is equal to zero (step S45). Further, in the setting procedure mentioned above, certain constant Me is added to a cost associated with a link which presents the largest amount of use (step S46). In the setting procedure mentioned above, the cost is set for all links within the network in accordance with foregoing steps S42 to S46.

Subsequently, the setting procedure mentioned above selects a light wave path having a minimum number of hops out of the light wave paths which have not been set, after the cost has been set for each link (step S47). Then, the setting procedure mentioned above selects a path which has a minimum total cost for the links installed between a start-point optical XC device and an end-point optical XC device on the selected light wave path (step S48).

The setting procedure mentioned above determines whether or not the cost for the selected light wave path is infinite (step S49), and sets the selected light wave path if the cost is not infinite.

Conversely, if the cost is infinite, the setting procedure mentioned above is terminated, regarded as a failure in locating the light wave path. As the light wave path is set, the setting procedure determines whether or not all the light wave paths have been set (step S50), and returns to step S22 if any light wave path remains not set. The setting procedure is terminated when all the light wave paths have been set.

The conventional setting procedure described above, however, has a problem that it cannot set the start-point optical XC device and end-point optical XC device because these devices have been given before the network is designed.

In addition, since the costs are given only for links which are set between the optical XC devices, the conventional setting procedure cannot necessarily reduce the number of transmitters and receives on a path which is set on the assumption that the start-point optical XC device and end-point optical Xc device have been determined.

For example, in an optical communication network illustrated in FIG. 2, when two light wave paths 701, 702 are set to a route “optical XC device 71—optical XC device 72”; two light wave paths 703, 704 to a route “optical XC device 72—optical XC device 74”; and one light wave path 705 to a route “optical XC device 71—optical XC device 73—optical Xc device 74,” with optical XC device 71 and optical XC device 74 being designated as the start-point XC device and end-point XC device, respectively, the product of the number of paths and the number of hops is calculated to be “4” for a route “optical XC device 71—optical XC device 72—optical XC device 74” while the product of the number of paths and the number of hops is calculated to be “2” for a route “optical XC device 71—optical XC device 73—optical XC device 74.” Thus, when an optical transmission path including an OADM is located to a route which presents a large product of the number of paths and the number of hops, the resulting optical transmission path will have the OADM installed in optical XC device 72. However, since all paths are inserted into or branched from optical XC device 72, no reduction is achieved for the number of transmitters and receivers.

### SUMMARY OF THE INVENTION

It is therefore an object of the present invention to provide an optical communication network and an optical communication network designing method used therefor which are capable of solving the above-mentioned problems and reducing a required number of transmitters and receivers.

It is another object of the present invention to provide an optical communication network and an optical communication network designing method used therefor which are capable of determining sites in which optical transmission paths including OADMs are located, and an order in which the optical transmission paths are routed.

A communication network according to the present invention includes a plurality of optical cross-connect devices each for performing an optical path cross connect function, a plurality of optical transmission paths for interconnecting the plurality of optical cross-connect devices, and a management device connected to each the optical cross-connect device through a control link and having a function of determining locations for a plurality of different optical cross-connect devices utilizing the amount of traffic on the optical transmission paths and the amount of traffic passing through the optical cross-connect devices.

Another optical communication network according to the present invention includes a plurality of optical cross-connect devices each for performing an optical path cross connect function, a plurality of optical transmission paths for interconnecting the plurality of optical cross-connect devices, and a management device included in each of the plurality of optical cross-connect devices and connected to adjacent optical cross-connect devices through control links, and having a function of determining locations for a plurality of different optical cross-connect devices utilizing the amount of traffic on the optical transmission paths and the amount of traffic passing through the optical cross-connect devices.

A method of designing an optical communication network according to the present invention is directed to an optical communication network including a plurality of optical cross-connect devices each for performing an optical path cross connect function, a plurality of optical transmission paths for interconnecting the plurality of optical cross-connect devices, and a management device connected to each of the optical cross-connect devices through a control link. The method includes the step of determining locations for a plurality of different optical cross-connect devices utilizing the amount of traffic on the optical transmission paths and the amount of traffic passing through the optical cross-connect devices.

Another method of designing an optical communication network according to the present invention is directed to an optical communication network including a plurality of optical cross-connect devices each for performing an optical path cross connect function, a plurality of optical transmission paths for interconnecting the plurality of optical cross-connect devices, and a management device included in each of the plurality of optical cross-connect devices and connected to adjacent optical cross-connect devices through control links. The method includes the step of determining locations for a plurality of different optical cross-connect devices utilizing the amount of traffic on the optical transmission paths and the amount of traffic passing through the optical cross-connect devices.

Specifically, the optical communication network according to the present invention includes optical XC devices each for switching a transmission path for a light wave path, optical communication paths for interconnecting the optical cross-connect devices, a management unit which stores network topology information and the amount of traffic passing through each optical XC device for calculating resource allocations, and a control link for transmitting the topology information and traffic information from each optical XC device to the manager unit.

The method of designing an optical communication system according to the present invention includes the steps of acquiring topology information and traffic information from each optical XC device through a control link, calculating an evaluation value in a combination of the amount of traffic on a link between the optical XC devices and the amount of traffic passing through each optical XC device; and determining routes through which ULHs (ultra long haul) are set, and an order in which the ULHs are routed.

With the configuration as described above, it is possible to determine sites through which ULHs are routed and the order in which they are routed, which result in a reduction in the number of transmitters and receivers, by use of the evaluation value which is based on the amount of traffic passing through each optical XC device as well as the amount of traffic on the link.

In other words, the optical communication network according to the present invention is advantageous in that a required number of transmitters and receivers can be reduced by determining the locations for a plurality of different optical cross-connect devices by use of the amount of traffic on the transmission paths and the amount of traffic passing through the optical cross-connect devices.

Another optical communication network according to the present invention can advantageously determine sites for locating optical transmission paths including OADMs, and the order in which they are routed in the foregoing configuration by determining locations for a plurality of different optical cross-connect devices, and the order in which they are installed.

### BRIEF DESCRIPTION OF THE DRAWINGS

FIG. 1 is a flow chart illustrating a conventional procedure for setting light wave paths;

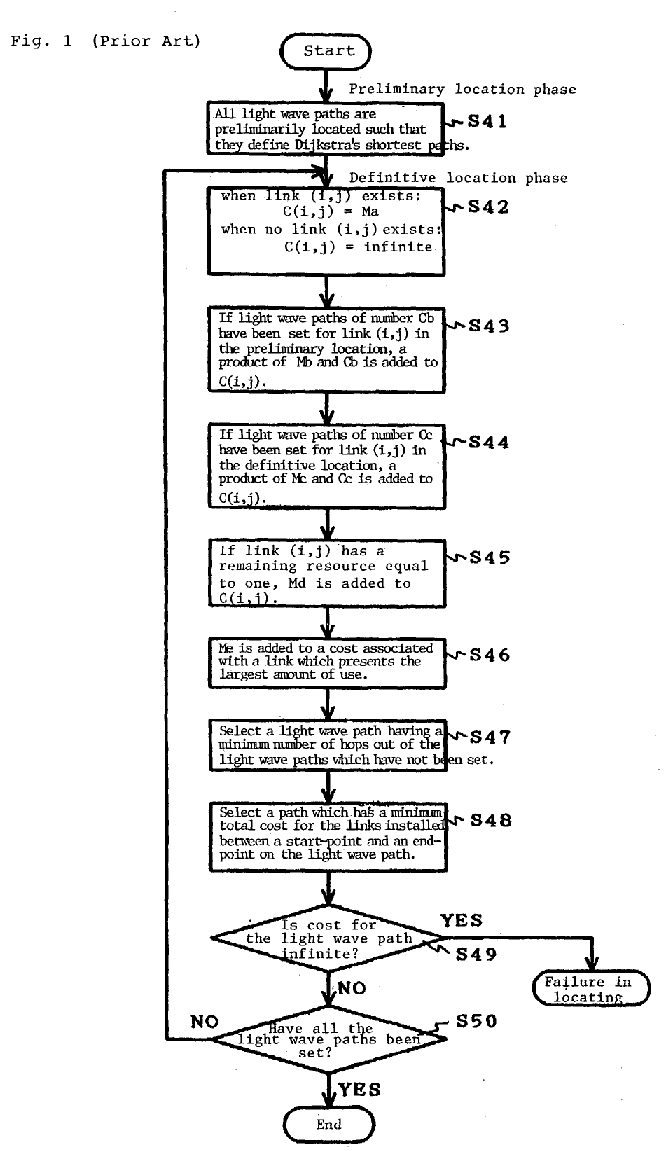

FIG. 2 is a diagram for describing a procedure for setting light wave paths in a conventional optical communication network;

FIG. 3 is a block diagram illustrating the configuration of an optical communication network according to one embodiment of the present invention;

FIG. 4 is a block diagram illustrating the configuration of an optical XC device through which ULH shown in FIG. 3 is not set;

FIG. 5 is a block diagram illustrating the configuration of an optical XC device for relaying ULH shown in FIG. 3;

FIG. 6 is a flow chart illustrating a procedure executed by a management device in FIG. 3 for determining locations for ULHs;

FIG. 7 is a diagram for describing an operational procedure according to one embodiment of the present invention;

FIG. 8 is a block diagram illustrating the configuration of a communication network according to another embodiment of the present invention;

FIG. 9 is a block diagram illustrating the configuration of an optical XC device through which ULH shown in FIG. 8 is not set;

FIG. 10 is a block diagram illustrating the configuration of an optical XC device through which ULH shown in FIG. 8 is set; and

FIG. 11 is a flow chart illustrating a procedure executed by a management unit for determining where ULHs are located according to another embodiment of the present invention.

### DETAILED DESCRIPTION OF THE PREFERRED EMBODIMENTS

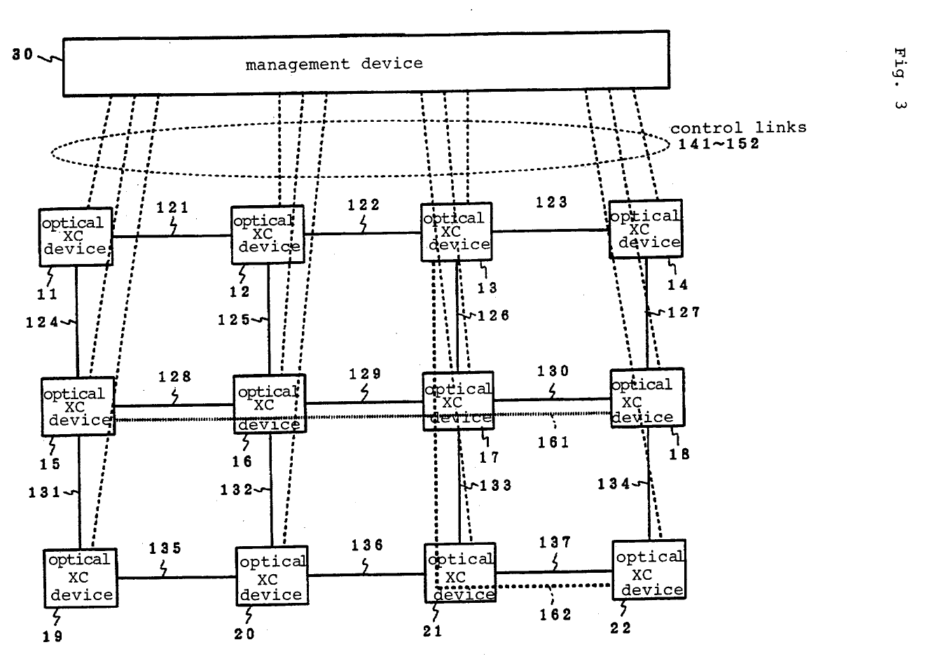

Next, embodiments of the present invention will be described with reference to the accompanying drawings. FIG. 3 is a block diagram illustrating the configuration of an optical communication network according to one embodiment of the present invention. In FIG. 3, the optical communication network according to one embodiment of the present invention comprises optical XC (cross-connect) devices 11-22; optical transmission paths 121-137 which interconnect these optical XC devices 11-22; management device 30; and control links 141-152 which connect optical XC devices 11-22 to management device 30.

Here, ULHs (ultra long haul) are set between some optical XC devices. In the example illustrated in FIG. 3, ULH 161 is set through optical XC devices 15, 16, 17, 18, while ULH 162 is set through optical XC devices 13, 17, 21, 22.

The ULH refers to an optical transmission system which enables long-distance transmissions without involving electric conversion. Also, one or more optical add-drop multiplexers (hereinafter abbreviated as “OADM”) can be inserted midway on a transmission path. Here, an optical transmission path including one or more OADMs between a transmitter and a receiver is called the ULH. The OADM has a function of inserting (adding) an optical signal into an optical transmission path or branching (dropping) an optical signal from an optical transmission path.

Though not shown, management device 30 has a function of storing topology information and traffic information transmitted from control links 141-152, a function of calculating resource allocations, and a function of outputting the result of the resource allocation calculation. These functions may include one implemented by a single device and one implemented by a plurality of devices. Costs between optical XC devices 11-22 may include the distances of transmission paths, and polarization mode dispersion, loss and the like which are the characteristics of the transmission paths.

The topology information may include connection relationships between optical XC devices 11-22, transmission costs between optical XC devices 11-22, and sizes of optical XC devices 11-22. The traffic information may include the start-point and end-point of a path, intermediate optical XC devices, a traffic amount, and the like.

Optical XC devices 11-22 each have a function of switching a course for a path transmitted over optical transmission paths 121-137. Optical XC devices 13, 15-18, 21, 22 through which ULH 161 or 162 is set differ in configuration from optical XC devices 11, 12, 14, 19, 20 through which no ULH is set. For this reason, the determination of locations for ULH may be paraphrased by determination of locations for different types of optical XC devices 11-22.

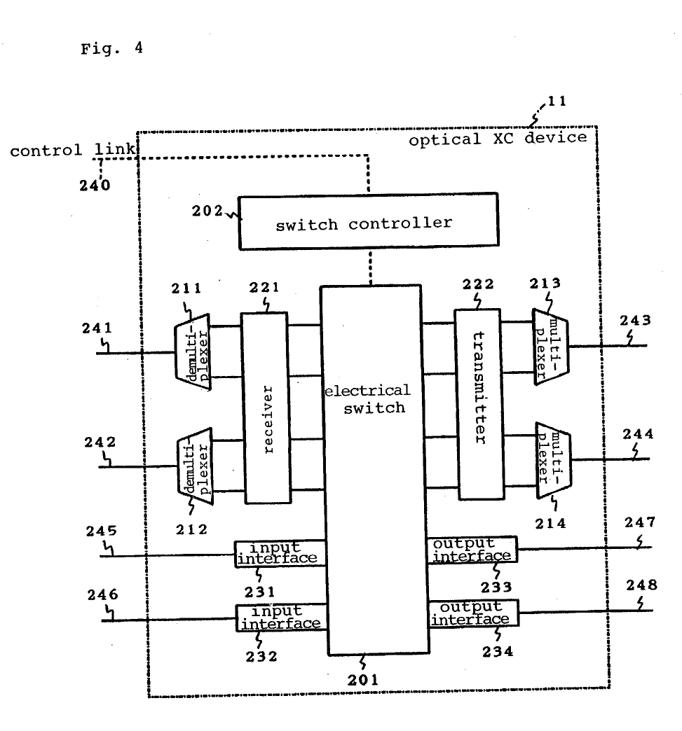

FIG. 4 is a block diagram illustrating the configuration of optical XC device 11 through which ULH shown in FIG. 3 is not set. In FIG. 4, optical XC device 11 comprises electric switch 201; switch controller 202; demultiplexers 211, 212; multiplexers 213, 214; receiver 221; transmitter 222; input interfaces (IF) 231, 232 each connected to a client; and output interfaces (IF) 233, 234. Remaining optical XC devices 12, 14, 19, 20 are similar in configuration to the foregoing optical XC device 11.

Receiver 221 converts an optical signal to an electrical signal. Transmitter 222 converts an electrical signal to an optical signal. When a transceiver having the functions of receiver 221 and transmitter 222 is substituted for receiver 221 and transmitter 222, an optical switch may be used instead of electrical switch 201.

Switch controller 202, which is connected to management device 30 of the network through a control link, transmits traffic information acquired from electrical switch 201. Input interfaces (Ifs) 231, 232 and output IFs 233, 234, which are connected to clients through transmission paths 245-248, each have a function of converting between a data structure handled by electrical switch 201 and a data structure handled by a client. When the same data structure is handled by electrical 201 and clients, input IFs 231, 232 and output IFs 233, 234 can be omitted.

Demultiplexers 211, 212 multiplexers 213, 214, which are connected to optical transmission paths 241-244 directed to adjacent optical XC devices, are required for wavelength division multiplexing (WDM) communications of signals between optical XC devices. Demultiplexers 211, 212 each demultiplex a plurality of wavelength on a single transmission path, while multiplexers 213, 214 each multiplex a plurality of wavelengths onto a wavelength band which bundles the plurality of wavelengths.

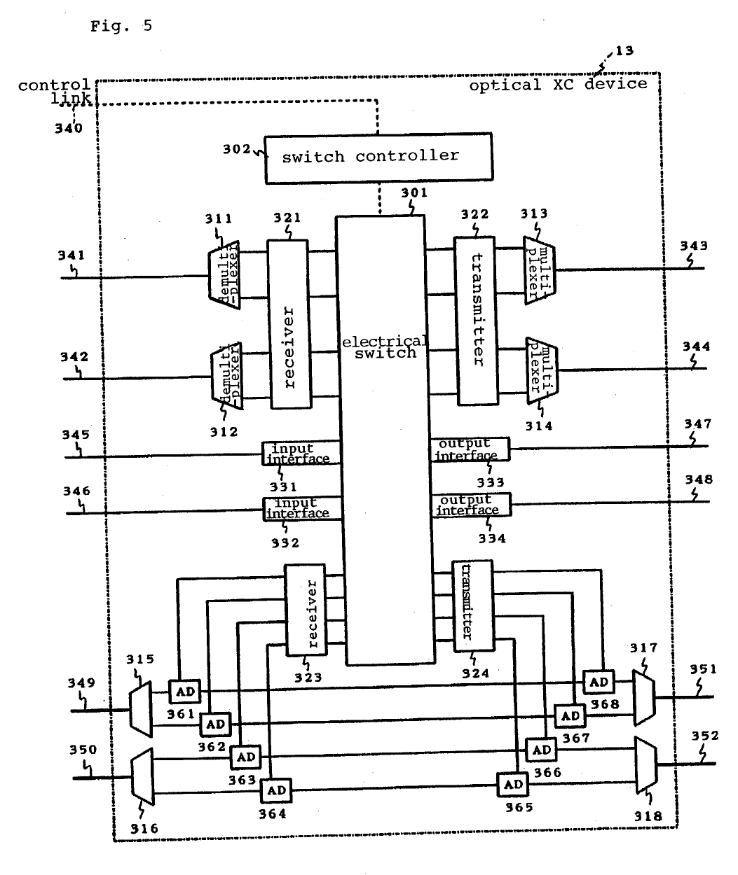

FIG. 5 is a block diagram illustrating the configuration of optical XC device 13 for relaying the ULH shown in FIG. 3. In FIG. 5, optical XC device 13 additionally comprises OADMs (optical add-drop multiplexer) 361-368 for relaying the ULH, and ULH transmission paths 349-352 in addition to optical XC device 11 illustrated in FIG. 4.

Specifically, optical XC device 13 comprises electrical switch 301; switch controller 302; demultiplexers 311, 312, 315, 316; multiplexers 313, 314, 317, 318; receivers 321, 323; transmitters 322, 324; input IFs 331, 332; output IFs 333, 334; and OADMs 361-368. Remaining optical XC devices 15-18, 21, 22 are similar in configuration to the foregoing optical XC device 11.

Optical transmission paths 341-344 connect optical XC device 13 to adjacent optical XC devices for transmitting optical signals. Transmission paths 345-348 are connected to clients.

OADMs 361-368 are inserted into ULH transmission paths 349-352 for branching (dropping) optical signals to electrical switch 301 or inserting (adding) optical signals from electric switch 301. OADM 361-368 eliminate the need for receivers and transmitters for all signal channels, thereby making it possible to economically build a network and also downsize the optical XC device.

A path passing through the optical XC device passes through OADMs 361-368. A path of a client, the destination of which is connected to this optical XC device 13, is branched into electrical switch 301 by OADMs 361-368, so that new signals are inserted into ULH transmission paths 349-352 through electrical switch 301 and OADMs 361-368.

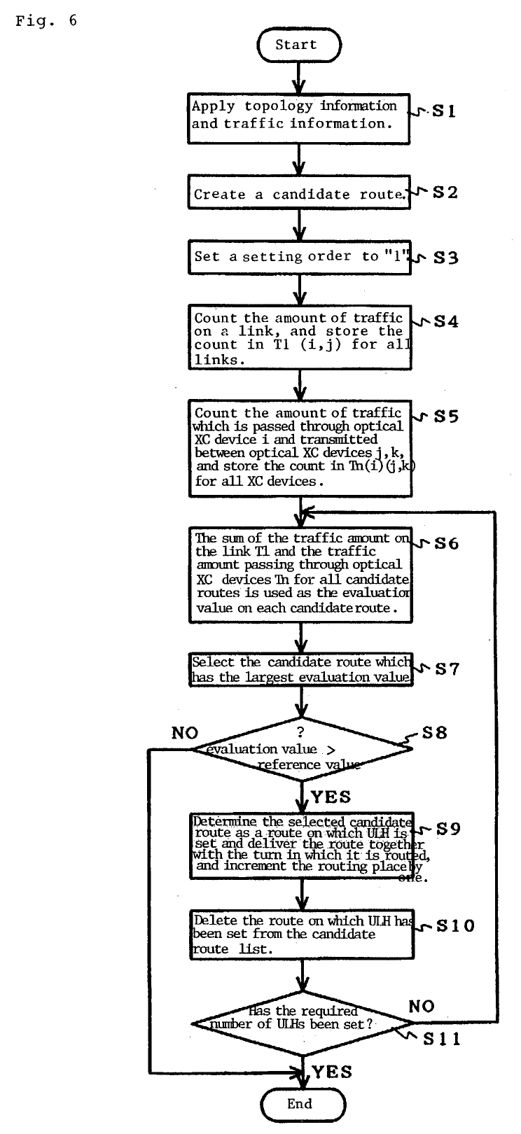

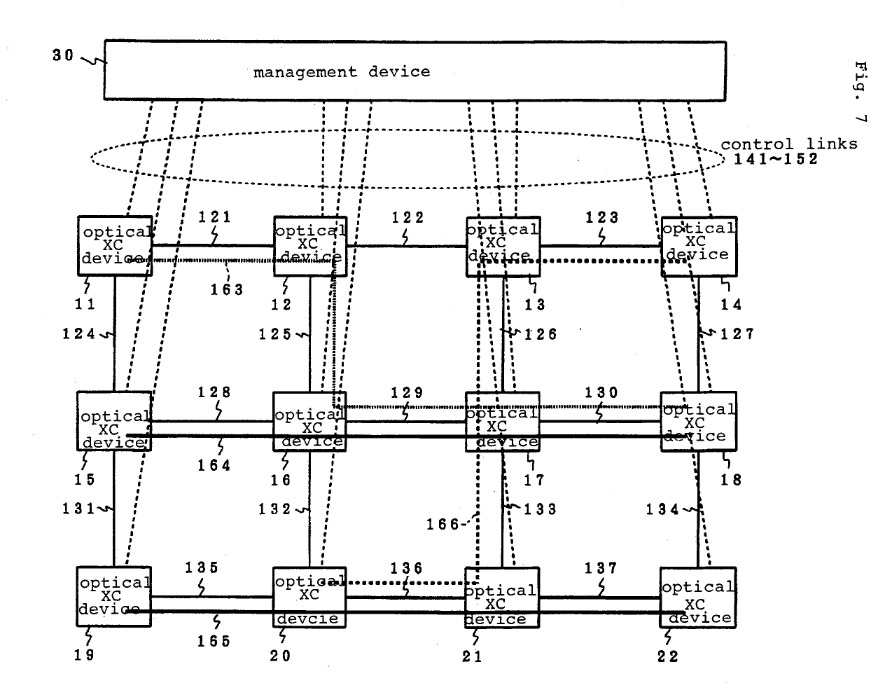

FIG. 6 is a flow chart illustrating a procedure executed by management device 30 in FIG. 3 for determining locations for ULHs, and FIG. 7 is a diagram for describing an operational procedure according to one embodiment of the present invention. The procedure executed by management device 30 for determining locations for ULHs will be described with reference to FIGS. 6 and 7. This procedure is intended for reducing a required number of transmitters and receivers. This procedure may be additionally intended for reducing the number of OADMs, the number of ports of the switch, the number of wavelengths, the overall transmission distance, and the sum of network components multiplied by respective unit prices. The network components include transmitters, receivers, combiners, dividers, amplifiers, transmission paths, branching devices, and the like.

In an optical communication network illustrated in FIG. 7, sites through which two ULHs are routed are determined in accordance with the flow chart illustrated in FIG. 6. While the optical communication network illustrated in FIG. 7 is identical in configuration to that illustrated in FIG. 3, no ULH has been set in FIG. 7. Assume that light wave paths 163-166 exist and pass through a route “optical XC device 11—optical XC device 12—optical XC device 16—optical XC device 17—optical XC device 18”; a route “optical XC device 15—optical XC device 16—optical XC device 17—optical XC device 18”; a route “optical XC device 19—optical XC device 20—optical XC device 21—optical XC device 22; and a route “optical XC device 20—optical XC device 21—optical XC device 17—optical XC device 13—optical XC device 14,” respectively. Assume also that light wave paths 163-166 have traffic amounts “1,” “2,” “1” and “2,” respectively.

When new ULH(s) need be set, management device 30 is applied with topology information and traffic information from optical XC devices 11-22 through control links 141-152, and stores therein the received topology information and traffic information (step S1 in FIG. 6).

Stored as the traffic information are the route “optical XC device 11—optical XC device 12—optical XC device 16—optical XC device 17—optical XC device 18” and traffic amount “1” corresponding to path 163; the route “optical XC device 15—optical XC device 16—optical XC device 17—optical XC device 18” and traffic amount “2” corresponding to path 164; the route “optical XC device 19—optical XC device 20—optical XC device 21—optical XC device 22” and traffic amount “2” corresponding to path 165; and the route “optical XC device 20—optical XC device 21—optical XC device 17—optical XC device 13—optical XC device 14” and traffic amount “1” corresponding to path 166, respectively.

Rather than acquiring the topology information and traffic information only when new ULH(S) must be located, management device 30 can alternatively have a function of periodically acquiring the topology information and traffic information for storage therein for a fixed time period. In this way, ULH(s) can be located with reference to the information in the past fixed time period, in the light of a forecast in the future.

Subsequently, management device 30 searches for routes within a distance range in which transmissions are available through the ULH, and creates a candidate route list which enumerates retrieved routes as candidate routes (step S2). The candidate route list describes a start-point optical XC device, an end-point optical XC device, and a intermediate optical XC device(s) for each route.

While the candidate route list can be created from the stored topology information, a manager can directly provide candidate routes. Assume herein that management device 30 is given routes which pass through “optical XC device 12—optical XC device 13—optical XC device 17—optical XC device 18”; “optical XC device 15—optical XC device 16—optical XC device 17—optical XC device 18”; and “optical XC device 20—optical XC device 21—optical XC device 17—optical XC device 18,” respectively as candidate routes. Management device 30 also sets a setting order to “1” (step S3).

Next, management device 30 counts the amount of traffic on a link between optical XC device i and optical XC device j, and stores the count in Tl (i,j) (step S4 in FIG. 4). Management device 30 performs this processing for all links in the network.

Subsequently, management device 30 counts the amount of traffic which is passed through optical XC device i and transmitted between optical XC devices j, k which are adjacent to optical XC device i, and stores the count in Tn(i)(j,k) (step S5). Management device 30 performs this processing for all XC devices in the network.

Management device 30 gives evaluation values for the candidate routes enumerated in the list at step S2 (step S6). Management device 30 utilizes the traffic amount on the link and the traffic amount passing through the optical XC devices.

Traffic amount Tl(i,j) on the link refers to the amount of traffic which passes through the link between optical XC device i and optical XC device j. For example, in FIG. 7, the amount of traffic on link 129 between optical XC device 16 and optical XC device 17 is given by the sum of the amounts of traffic on path 163 and path 164, so that traffic amount Ti(16, 17) is calculated to be “3.”

The amount of traffic Tn(i)(j,k) passing through optical XC devices refers to the amount of traffic which passes through optical XC device i and two optical XC devices j, k adjacent thereto. For example, in FIG. 7, traffic amount Tn(16)(15, 17) is calculated to be “2” because path 164 alone passes through optical XC devices 15-17.

The traffic amount on the link and the traffic amount passing through optical XC devices are multiplied by appropriate weighting coefficients, respectively, and resulting products are summed for use as an evaluation value. The sum of a*Tl and b*Tn on each candidate route is used as the evaluation value, where a, b are constants. A larger number of transmitters and receivers can be reduced when b is equal to or larger than a.

When a number n of ULHs have been set on link (i,j), the product of cl to n-th power and Tl(i,j) is used as the evaluation value, where cl is a constant. Alternatively, when a number n of ULHs have been set such that they pass through both link (i,j) and link (j,k), the product of cn to n-th power and Tn(j)(i,k) is used as the evaluation value. Cl may be equal to cn.

In FIG. 7, each candidate route is given the evaluation value, where a=1, b=2. A candidate route passing through “optical XC device 12—optical XC device 13—optical XC device 17—optical XC device 18” is given the evaluation value “5”; a candidate route passing through “optical XC device 15—optical XC device 16—optical XC device 17—optical XC device 18” is given the evaluation value “18”; and a candidate route passing through “optical XC device 19—optical XC device 20—optical XC device 21—optical XC device 22” is given the evaluation value “9.”

After giving the evaluation values to all the candidate routes, management device 30 selects the candidate route which has the largest evaluation value (step S7 in FIG. 6). In FIG. 7, management device 30 selects the candidate route which passes through “optical XC device 15—optical XC device 16—optical XC device 17—optical XC device 18” from the three candidate routes.

Management device 30 determines whether or not the evaluation value of the selected candidate route is larger than a predefined reference value (step S8), determines the selected candidate route as a route on which ULH is set when the evaluation value is larger than the reference value, delivers the selected candidate route together with the turn in which it is routed, and increments the setting order by one (step S9). In FIG. 7, assume that the reference value is set at “5.” Since the traffic amount on the candidate route selected at step 7 is larger than the reference value, management device 30 delivers the route which passes “optical XC device 15—optical XC device 16—optical XC device 17—optical XC device 18” as a route on which ULH should be routed first. The reference value may be set at any value. Since the evaluation value indicates the amount of cost reduced by setting the ULH, the reference value can be regarded as a cost for setting one ULH, thereby automatically terminating the procedure of FIG. 6 with a number of ULHs which minimizes the cost of the overall network.

Management device 30 deletes the route on which ULH has been set from the candidate route list (step S10). In FIG. 7, since the route passing through “optical XC device 15—optical XC device 16—optical XC device 17—optical XC device 18”, is deleted from the candidate route list, the candidate routes passing through “optical XC device 12—optical XC device 13—optical XC device 17—optical XC device 18”, and “optical XC device 20—optical XC device 21—optical XC device 17—optical XC device 18, respectively, remain in the candidate route list.

Management device 30 repeats steps S6 to S11 until a required number of ULHs are set. Management device 30 terminates the procedure of FIG. 6 when the required number of ULHs has been set (step S11) or when the evaluation value of the selected candidate route is lower than the reference value (step S8).

In FIG. 7, since two ULHs are required, management device 30 updates the evaluation value for each candidate route after the first ULH has been set. Since the ULH has been set on the route which passes through “optical XC device 15—optical XC device 16—optical XC device 17—optical XC device 18,” the candidate route passing through “optical XC device 12—optical XC device 13—optical XC device 17—optical XC device 18” has the traffic amount “2.5”; and the candidate route passing through “optical XC device 20—optical XC device 21—optical XC device 17—optical XC device 18”, has the traffic amount “5.5,” when cl and cn are set to 0.5 (step S6).

Since the candidate route passing through “optical XC device 20—optical XC device 21—optical XC device 17—optical XC device 18” has the largest evaluation value, management device 30 delivers this candidate route as the second route on which ULH is located. Thus, The management device 30 has selected the routes for the required number of ULHs, followed by termination of the procedure in the flow chart illustrated in FIG. 6.

While in one embodiment of the present invention, the management of all optical XC devices 11-22 is centralized on management device 30, each optical XC device may be provided with a management device instead of the centralized management of all XC devices 11-22 by management device 30.

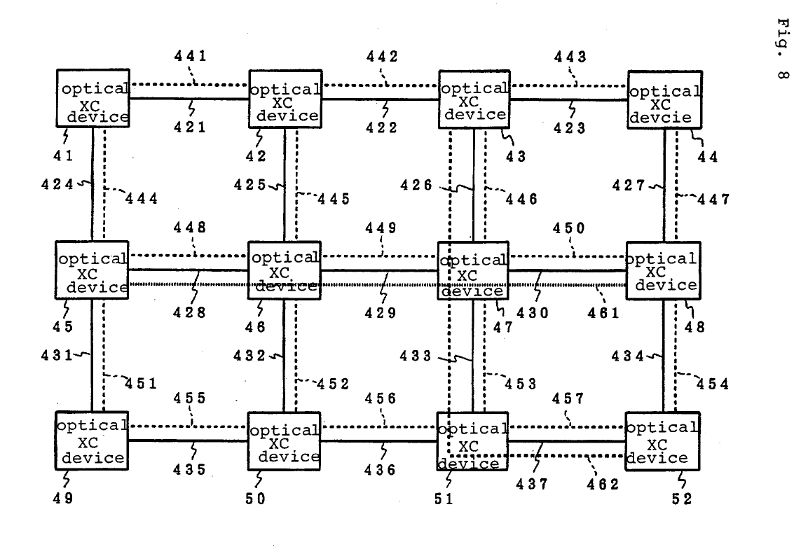

FIG. 8 is a block diagram illustrating the configuration of a communication network according to another embodiment of the present invention. In the communication network according to this embodiment of the present invention illustrated in FIG. 8, management devices in respective optical XC devices 41-52 exchange topology information and traffic information through control links 441-457 which interconnect respective optical XC devices, so that they can create a candidate route list for determining routes on which ULHs should be routed.

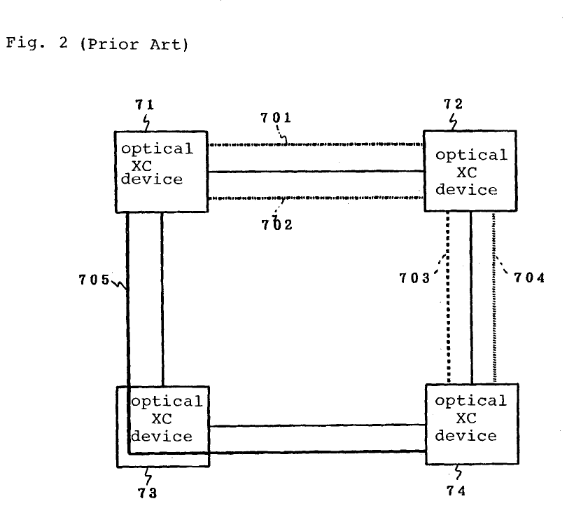

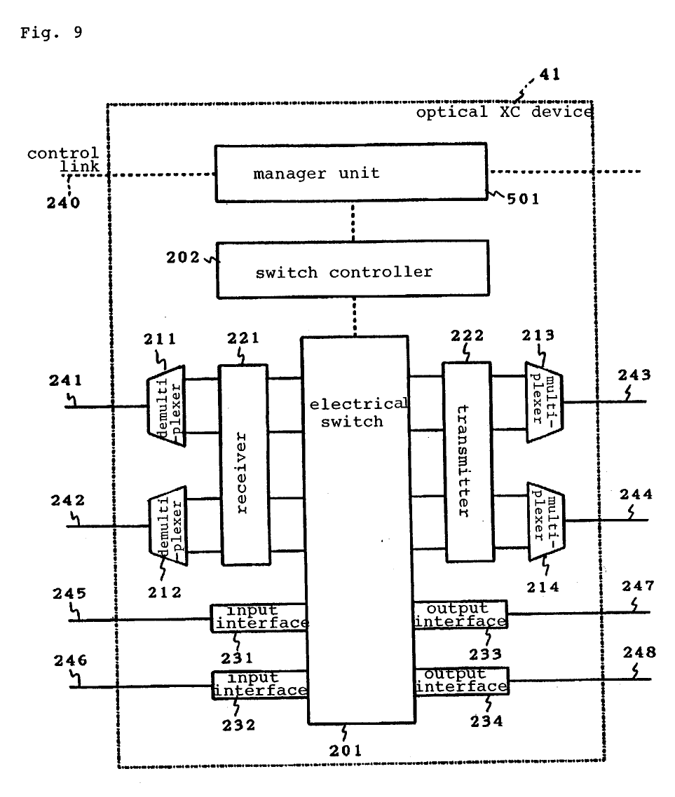

FIG. 9 is a block diagram illustrating the configuration of optical XC device 41 through which ULH shown in FIG. 8 is not set. In FIG. 9, optical XC device 41 is similar in configuration to optical XC device 11 illustrated in FIG. 2 except that management unit 501 is added, wherein the same components are designated the same reference numerals. Also, the same components are similar in operation to the counterparts in optical XC device 11 illustrated in FIG. 2. Further, remaining optical XC devices 42, 44, 49, 50, through which no ULH is set, are similar in configuration to the aforementioned optical XC device 11.

Though not shown, manager unit 501 has a function of storing topology information and traffic information transmitted from adjacent optical XC devices through control link 240, a function of calculating resource allocations, and a function of outputting the result of the resource allocation calculation. These functions may include one implemented by a single device and one implemented by a plurality of devices.

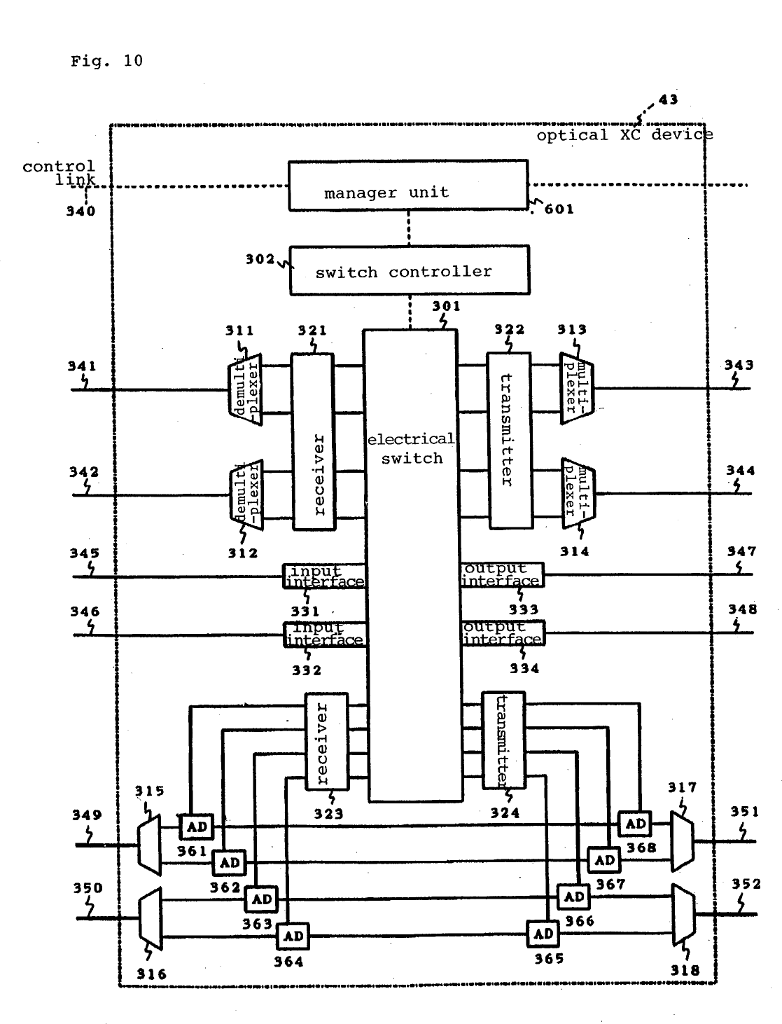

FIG. 10 is a block diagram illustrating the configuration of optical XC device 43 through which the ULH shown in FIG. 8 is set. In FIG. 10, optical XC device 43 is similar in configuration to optical XC device 13 illustrated in FIG. 5 except that management unit 601 is added, wherein the same components are designated the same reference numerals. Also, the same components are similar in operation to the counterparts in optical XC device 13 illustrated in FIG. 5. Further, remaining optical XC devices 45-48, 51, 52, through which ULH is set, are similar in configuration to the aforementioned optical XC device 13.

Though not shown, manager unit 601 has a function of storing topology information and traffic information transmitted from adjacent optical XC devices through control link 340, a function of calculating resource allocations, and a function of outputting the result of the resource allocation calculation. These functions may include one implemented by a single device and one implemented by a plurality of devices.

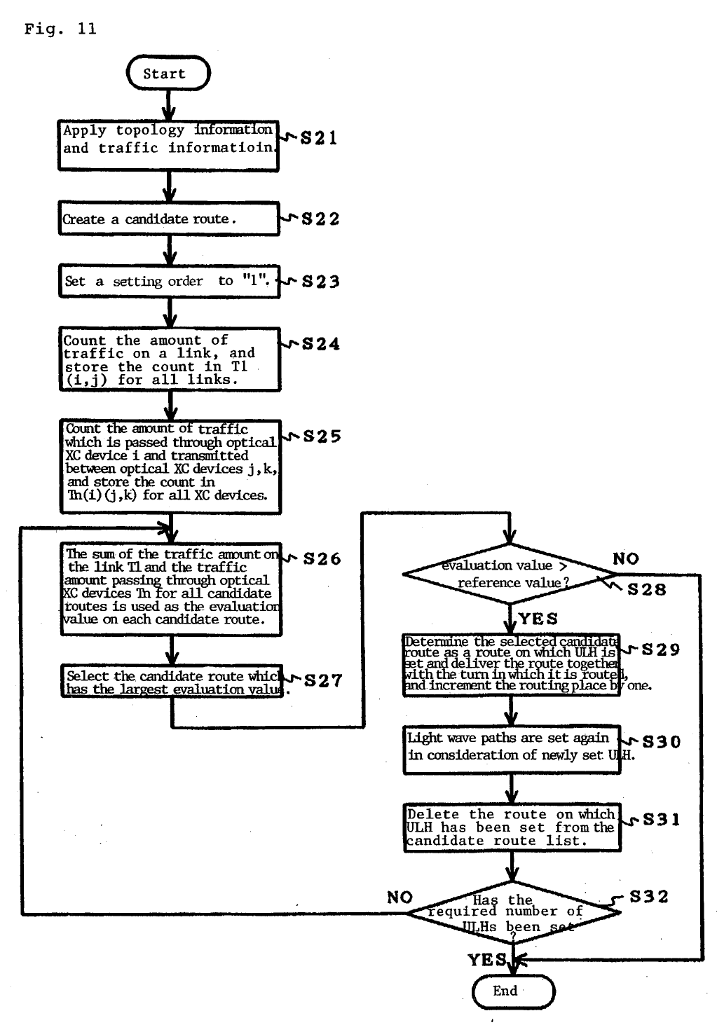

FIG. 11 is a flow chart illustrating a procedure of the management unit for determining locations for ULHs according to another embodiment of the present invention. Though not shown, a communication network according to this embodiment may be identical in configuration to that of the one embodiment or any of the other embodiments of the present invention.

In FIG. 11, the illustrated procedure is similar to that illustrated in FIG. 6 except for additional step S30 at which light wave paths are routed again in consideration of newly set ULH. Since steps S21-S29, S31, S32 are similar to steps S1-S11 in FIG. 6, description thereon is omitted. In addition, step A30 may be replaced with step S31.

Thus, the light wave paths can be set in accordance with the Dijkstra's algorithm, resulting in a reduction in the cost for links through which ULHs have been located from the cost before the location of ULHs. As such, since the paths are routed to use more ULHs, a further reduction can be achieved in the number of transmitters and receivers.

As appreciated, the present invention can determine an optical XC device located at the start point and an optical XC device located at the end point by selecting routes on which transmissions can be available through ULHs from topology information, and utilizing the routes as candidate routes.

In addition, the present invention can determine sites through which ULHs are routed and the order in which the ULHs are set for effectively reducing a required number of transmitters and receivers, with the inclusion of the amount of traffic passing through optical XC devices in the evaluation value for determining the sites through which the ULHs are routed.

What is claimed is:

1. A communication network comprising:
a plurality of cross-connect devices each for performing a path cross connect function;
a plurality of transmission paths for interconnecting said plurality of cross-connect devices; and
a management device connected to each said cross-connect device through a control link, said management device having a function of determining locations for a plurality of different cross-connect devices utilizing an amount of traffic on said transmission paths and the amount of traffic passing through said cross-connect devices.

2. A communication network comprising:
a plurality of cross-connect devices each for performing a path cross connect function;
a plurality of transmission paths for interconnecting said plurality of cross-connect devices; and
a management device included in each of said plurality of cross-connect devices and connected to adjacent cross-connect devices through control links, said management device having a function of determining locations for a plurality of different cross-connect devices utilizing an amount of traffic on said transmission paths and the amount of traffic passing through said cross-connect devices.

3. The communication network according to claim 1, further comprising:
means for determining the locations for said plurality of different cross-connect devices and an order in which said cross-connect devices are installed.

4. The communication network according to claim 2, further comprising:
means for determining the locations for said plurality of different cross-connect devices and an order in which said cross-connect devices are installed.

5. An optical communication network comprising:
a plurality of optical cross-connect devices each for performing an optical path cross connect function;
a plurality of optical transmission paths for interconnecting said plurality of optical cross-connect devices; and
a management device connected to each said optical cross-connect device through a control link, said management device having a function of determining locations for a plurality of different optical cross-connect devices utilizing an amount of traffic on said optical transmission paths and the amount of traffic passing through said optical cross-connect devices.

6. An optical communication network comprising:
a plurality of optical cross-connect devices each for performing an optical path cross connect function;
a plurality of optical transmission paths for interconnecting said plurality of optical cross-connect devices; and
a management device included in each of said plurality of optical cross-connect devices and connected to adjacent optical cross-connect devices through control links, said management device having a function of determining locations for a plurality of different optical cross-connect devices utilizing an amount of traffic on said optical transmission paths and the amount of traffic passing through said optical cross-connect devices.

7. The optical communication network according to claim 5, further comprising:
means for determining the locations for said plurality of different optical cross-connect devices and an order in which said optical cross-connect devices are installed.

8. The optical communication network according to claim 6, further comprising:
means for determining the locations for said plurality of different optical cross-connect devices and an order in which said optical cross-connect devices are installed.

9. The optical communication network according to claim 5, wherein:
said optical cross-connect devices comprise optical add-drop multiplexers.

10. The optical communication network according to claim 5, wherein:
said optical cross-connect devices comprise switches with a function of optical-electrical-optical conversion.

11. The optical communication network according to claim 5, wherein:
said optical cross-connect devices comprise switches with a function of optical switching.

12. A method of designing an optical communication network including a plurality of optical cross-connect devices each for performing an optical path cross connect function, a plurality of optical transmission paths for interconnecting said plurality of optical cross-connect devices, and a management device connected to each said optical cross-connect device through a control link, said method comprising the step of:
determining locations for a plurality of different optical cross-connect devices utilizing an amount of traffic passing through said optical cross-connect devices.

13. A method of designing an optical communication network including a plurality of optical cross-connect devices each for performing an optical path cross connect function, a plurality of optical transmission paths for interconnecting said plurality of optical cross-connect devices, and a management device included in each of said plurality of optical cross-connect devices and connected to adjacent optical cross-connect devices through control links, said method comprising the step of:
determining locations for a plurality of different optical cross-connect devices utilizing an amount of traffic passing through said optical cross-connect devices.

14. The method of designing an optical communication network according to claim 12, further comprising the step of:
determining the locations for said plurality of different optical cross-connect devices and an order in which said optical cross-connect devices are installed.

15. The method of designing an optical communication network according to claim 13, further comprising the step of:
determining the locations for said plurality of different optical cross-connect devices and an order in which said optical cross-connect devices are installed.

16. A method of designing an optical communication network including a plurality of optical cross-connect devices each for performing an optical path cross connect function, a plurality of optical transmission paths for interconnecting said plurality of optical cross-connect devices, and a management device connected to each said optical cross-connect device through a control link, said method comprising the step of:
determining locations for a plurality of different optical cross-connect devices utilizing an amount of traffic on said optical transmission paths and the amount of traffic passing through said optical cross-connect devices.

17. A method of designing an optical communication network including a plurality of optical cross-connect devices each for performing an optical path cross connect function, a plurality of optical transmission paths for interconnecting said plurality of optical cross-connect devices, and a management device included in each of said plurality of optical cross-connect devices and connected to adjacent optical cross-connect devices through control links, said method comprising the step of:
determining locations for a plurality of different optical cross-connect devices utilizing an amount of traffic on said optical transmission paths and the amount of traffic passing through said optical cross-connect devices.

18. The method of designing an optical communication network according to claim 16, further comprising the step of:
determining the locations for said plurality of different optical cross-connect devices and an order in which said optical cross-connect devices are installed.

19. The method of designing an optical communication network according to claim 17, further comprising the step of:
determining the locations for said plurality of different optical cross-connect devices and an order in which said optical cross-connect devices are installed.

20. A method of designing an optical communication network including a plurality of optical cross-connect devices each for performing an optical path cross connect function, a plurality of optical transmission paths for interconnecting said plurality of optical cross-connect devices, and a management device connected to each said optical cross-connect device through a control link, said method comprising:
a first step of applying topology information and traffic information;
a second step of creating a candidate route;
a third step of setting a routing place to “1”;
a fourth step of counting an amount of traffic on a link between optical cross-connect devices i, j, and store a count in T1 (i,j) for all links;
a fifth step of counting the amount of traffic which is passed through optical cross-connect device i and transmitted between optical cross-connect devices j, k, and store the count in Tn(i)(j,k) for all cross-connect devices;
a sixth step of using a sum of the traffic amount on the link Tl and the traffic amount passing through optical cross-connect devices Tn for all candidate routes as an evaluation value on each candidate route;
a seventh step of selecting the candidate route which has a largest evaluation value;
an eighth step of determining whether or not the evaluation value of the selected candidate route is larger than a predefined reference value, going to a ninth step when the evaluation value of the selected candidate route is larger than the reference value and terminating when the evaluation value of the selected candidate route is not larger than the reference value;
a ninth step of determine the selected candidate route as a route on which ultra long haul (ULH) is set and deliver the route together with a turn in which it is routed, and increment the routing place by one;
a tenth step of deleting the route on which ultra long haul (ULH) has been set from a candidate route list; and
an eleventh step of determining whether or not a required number of ultra long hauls (ULHs) has been set, repeating from the sixth step to the eleventh step when the required number of ULHs has not been set and terminating when the required number of ULHs has not been set.

21. A method of designing an optical communication network including a plurality of optical cross-connect devices each for performing an optical path cross connect function, a plurality of optical transmission paths for interconnecting said plurality of optical cross-connect devices, and a management device connected to each said optical cross-connect device through a control link, said method comprising:
a first step of applying topology information and traffic information;
a second step of creating a candidate route;
a third step of setting a routing place to “1”;
a fourth step of counting an amount of traffic on a link between optical cross-connect devices i, j, and store a count in T1 (i,j) for all links;
a fifth step of counting the amount of traffic which is passed through optical cross-connect device i and transmitted between optical cross-connect devices j, k, and store the count in Tn(i)(j,k) for all cross-connect devices;
a sixth step of using a sum of the traffic amount on the link Tl and the traffic amount passing through optical cross-connect devices Tn for all candidate routes as an evaluation value on each candidate route;
a seventh step of selecting the candidate route which has a largest evaluation value;
an eighth step of determining whether or not the evaluation value of the selected candidate route is larger than a predefined reference value, going to a ninth step when the evaluation value of the selected candidate route is larger than the reference value and terminating when the evaluation value of the selected candidate route is not larger than the reference value;
a ninth step of determine the selected candidate route as a route on which ultra long haul (ULH) is set and deliver the route together with a turn in which it is routed, and increment the routing place by one;
a tenth step of setting again light wave paths in consideration of newly set ULH;
an eleventh step of deleting the route on which ULH has been set from a candidate route list; and
a twelfth step of determining whether or not a required number of ultra long hauls (ULHs) has been set, repeating from the sixth step to the eleventh step when the required number of ULHs has not been set and terminating when the required number of ULHs has not been set.

22. A method of designing an optical communication network including a plurality of optical cross-connect devices each for performing an optical path cross connect function, a plurality of optical transmission paths for interconnecting said plurality of optical cross-connect devices, and a management device connected to each said optical cross-connect device through a control link, said method comprising the steps of:
multiplying a traffic amount on the control link and a traffic amount passing through optical cross-connect devices by appropriate weighting coefficients, respectively;
summing resulting products for use as an evaluation value; and
determining locations for optical cross-connect devices which have a largest evaluation value.

23. A method of designing an optical communication network including a plurality of optical cross-connect devices each for performing an optical path cross connect function, a plurality of optical transmission paths for interconnecting said plurality of optical cross-connect devices, and a management device connected to each said optical cross-connect device through a control link, said method comprising the steps of:
multiplying a traffic amount on the control link and a traffic amount passing through optical cross-connect devices by appropriate weighting coefficients, respectively;
summing resulting products for use as an evaluation value; and
determining locations for optical cross-connect devices which have a largest evaluation value and are larger than a predefined threshold value.

24. The method of designing an optical communication network according to claim 23, wherein:
said threshold value is set by a value proportional to an installation cost of said optical cross-connect devices.

25. A method of designing an optical communication network including a plurality of optical cross-connect devices each for performing an optical path cross connect function, a plurality of optical transmission paths for interconnecting said plurality of optical cross-connect devices, and a management device connected to each said optical cross-connect device through a control link, said method comprising the steps of:
obtaining traffic information; and
anticipating future locations for network devices in consideration of past traffic information.
